(19) United States
(12) Patent Application Publication
(10) Pub. No.: US 2021/0061086 A1
(43) Pub. Date: Mar. 4, 2021

(54) HYBRID VEHICLE

(71) Applicant: TOYOTA JIDOSHA KABUSHIKI KAISHA, Toyota-shi, Aichi (JP)

(72) Inventor: Kenji ITAGAKI, Suntou-gun (JP)

(73) Assignee: TOYOTA JIDOSHA KABUSHIKI KAISHA, Toyota-shi, Aichi (JP)

(21) Appl. No.: 16/962,373

(22) PCT Filed: Dec. 25, 2018
(86) PCT No.: PCT/JP2018/047674

§ 371 Date: Jul. 15, 2020

(30) Foreign Application Priority Data
Jan. 29, 2018 (JP) 2018-012525

(51) Int. Cl. B60K 6/42; B60W 10/06; B60W 10/08

(52) U.S. Cl. CPC B60K 6/42; B60W 2710/0666; B60W 10/08; B60W 10/06

(57) ABSTRACT

A hybrid vehicle includes: an engine; an output member transmitting a driving force to drive wheels; a rotating electric machine; and a power split mechanism splitting and transmitting a driving force from the engine to the output member and the rotating electric machine. Further, the power split mechanism includes an input element, connected to the engine; a reaction force element, connected to the rotating electric machine; and an output element, connected to the output member, when an engine rotation speed is to be increased, an engine torque is output by adding an engine inertia torque to an engine required torque, and a reaction force torque, corresponding to the engine required torque, is output by the rotating electric machine, and a feedback torque, constituting a feedback system with respect to a target rotation speed of the engine, is output as the reaction force torque of the rotating electric machine.

### FIELD

The present invention relates to a hybrid vehicle.

### BACKGROUND

Patent Literature 1 discloses that in a hybrid vehicle equipped with an engine including a supercharger, in order to suppress over-rotation of a motor generator due to a sudden increase in torque, when the engine is driven in a supercharged state, a rising speed of an engine rotation speed is controlled by a motor generator.

### CITATION LIST

### Patent Literature

Patent Literature 1: Japanese Laid-open Patent Publication No. 2015-107685

### SUMMARY

### Technical Problem

However, in the hybrid vehicle disclosed in Patent Literature 1, when control is performed to transiently output engine torque more than limited by motor generator torque, there is a room for an improvement of considering how the motor generator should be controlled.

The present invention has been made in view of the above problem, and has an object to provide a hybrid vehicle that can improve the followability to a target rotation speed when an engine rotation speed is increased.

### Solution to Problem

To resolve the above problem and attain the object, a hybrid vehicle according to a present invention includes: an engine; an output member that transmits a driving force to drive wheels; a rotating electric machine; and a power split mechanism that splits and transmits a driving force output from the engine to the output member and the rotating electric machine. Further, the power split mechanism includes at least three rotating elements, which are an input element, connected to the engine, a reaction force element, connected to the rotating electric machine, and an output element, connected to the output member, when an engine rotation speed is to be increased, an engine torque is output by adding an engine inertia torque to an engine required torque, and a reaction force torque, corresponding to the engine required torque, is output by the rotating electric machine, and a feedback torque, constituting a feedback system with respect to a target rotation speed of the engine, is output as the reaction force torque of the rotating electric machine.

Further, in the above hybrid vehicle, the engine includes a supercharger, and an output torque of the engine is increased by operating the supercharger.

As a result, the engine rotation speed can be quickly increased in order to rotate a turbine of the supercharger.

### Advantageous Effects of Invention

When the engine rotation speed is to be increased, the hybrid vehicle according to the present invention can perform control with torque of a motor generator having a fast response. Thus, there is provided an effect that, as compared with the case where the feedback torque is output from the engine, the followability to the target rotation speed can be improved.

### BRIEF DESCRIPTION OF DRAWINGS

FIG. 1 is a skeleton diagram illustrating an example of a power train of a hybrid vehicle.

FIG. 2 is an alignment chart of a power split mechanism constituted by a single pinion type planetary gear mechanism of FIG. 1.

FIG. 3 is a time chart illustrating an example of changes in target engine rotation speed, engine torque, torque of a first motor generator, and a driving force when the vehicle is accelerated from steady traveling.

FIG. 4 is a flowchart illustrating an example of control performed by an ECU to compute engine torque that is actually commanded to an engine.

### DESCRIPTION OF EMBODIMENTS

Hereinafter, an embodiment of a hybrid vehicle according to the present invention will be described. Note that the present invention is not limited by the present embodiment.

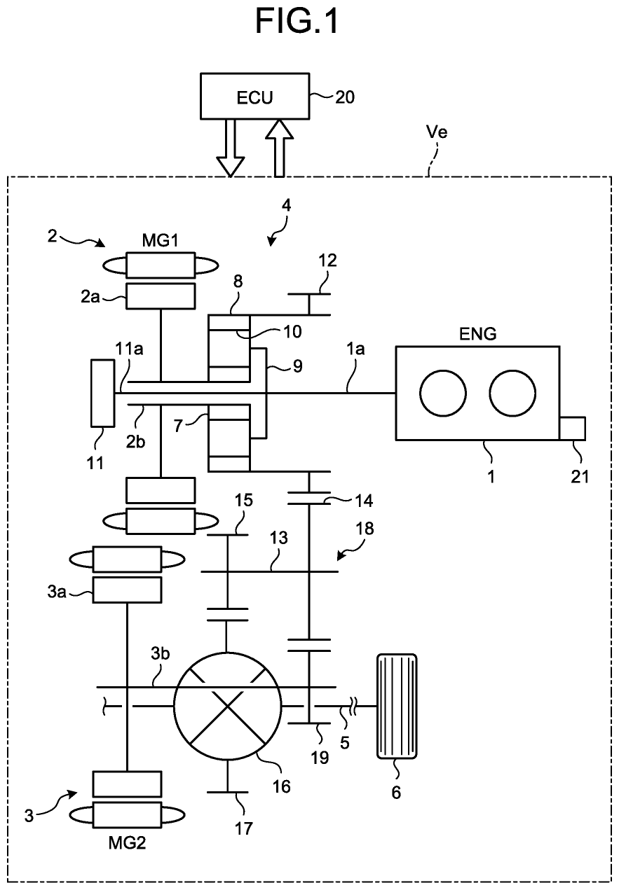

FIG. 1 is a skeleton diagram illustrating an example of a power train of a hybrid vehicle Ve. The hybrid vehicle Ve includes a plurality of driving power sources including an engine (ENG) 1 as a main motor, a first motor generator (MG1) 2 as a rotating electric machine, and a second motor generator (MG2) 3 as a rotating electric machine. The hybrid vehicle Ve is configured to split and transmit power output from the engine 1 to the first motor generator 2 side and a drive shaft 5 side by a power split mechanism 4. The power generated by the first motor generator 2 is supplied to the second motor generator 3, and a driving force output by the second motor generator 3 can be added to the drive shaft 5 and a drive wheel 6.

Each of the first motor generator 2 and the second motor generator 3 has both a function as a motor that outputs torque by being supplied with driving power and a function as a generator that generates generated power by being supplied with torque (power generation function). Note that the first motor generator 2 and the second motor generator 3 are electrically connected to a power storage device such as a battery or a capacitor via an inverter or the like (not illustrated), and can be supplied with power from the power storage device and charge generated power to the power storage device.

The power split mechanism 4 is arranged on the same axis as the engine 1 and the first motor generator 2. An output shaft la of the engine 1 is connected to a carrier 9 which is an input element of a planetary gear mechanism constituting the power split mechanism 4. The output shaft la serves as an input shaft of the power split mechanism 4 in a power transmission path from the engine 1 to the drive wheel 6. A rotation shaft lla of an oil pump 11 that supplies oil for lubrication and cooling of the power split mechanism 4 and for cooling heat generated by copper loss and iron loss of the first motor generator 2 and the second motor generator 3 is connected to the carrier 9.

The first motor generator 2 is arranged adjacent to the power split mechanism 4 and on the side opposite to the engine 1, and a rotor shaft 2b that rotates integrally with a rotor 2a of the first motor generator 2 is connected to a sun gear 7 which is a reaction force element of the planetary gear mechanism. The rotor shaft 2b and a rotation shaft of the sun gear 7 are hollow shafts. The rotation shaft lla of the oil pump 11 is arranged in the hollow portions of the rotor shaft 2b and the rotation shaft of the sun gear 7, and the rotation shaft lla is connected to the output shaft la of the engine 1 through the hollow portions.

A first drive gear 12 of an external gear which is an output member is formed integrally with a ring gear 8 on an outer peripheral portion of the ring gear 8 which is an output element of the planetary gear mechanism. Further, a counter shaft 13 is arranged in parallel with the rotation axis of the power split mechanism 4 and the first motor generator 2. A counter driven gear 14 that meshes with the first drive gear 12 is attached to one end of the counter shaft 13 so as to rotate integrally. The counter driven gear 14 is formed to have a larger diameter than the first drive gear 12, and is configured to amplify torque transmitted from the first drive gear 12. Meanwhile, a counter drive gear 15 is attached to the other end of the counter shaft 13 so as to rotate integrally with the counter shaft 13. The counter drive gear 15 meshes with a differential ring gear 17 of a differential gear 16. Therefore, the ring gear 8 of the power split mechanism 4 is connected to the drive shaft 5 and the drive wheel 6 so that power can be transmitted via an output gear train 18 including the first drive gear 12, the counter shaft 13, the counter driven gear 14, the counter drive gear 15, and the differential ring gear 17.

The power train of the hybrid vehicle Ve is configured such that the torque output from the second motor generator 3 can be added to the torque transmitted from the power split mechanism 4 to the drive shaft 5 and the drive wheel 6. Specifically, a rotor shaft 3b that rotates integrally with a rotor 3a of the second motor generator 3 is arranged in parallel with the counter shaft 13. A second drive gear 19 that meshes with the counter driven gear 14 is attached to a distal end of the rotor shaft 3b so as to rotate integrally. Therefore, the second motor generator 3 is connected to the ring gear 8 of the power split mechanism 4 via the differential ring gear 17 and the second drive gear 19 so that power can be transmitted. That is, the ring gear 8 is connected to the drive shaft 5 and the drive wheel 6 via the differential ring gear 17 together with the second motor generator 3 so that power can be transmitted.

The hybrid vehicle Ve operates in traveling modes such as a hybrid traveling mode (HV traveling) mainly using the engine 1 as a power source, and an electric traveling mode (EV traveling) in which the first motor generator 2 and the second motor generator 3 are driven to travel by power of the power storage device. Such setting and switching of each traveling mode are executed by an electronic control device (ECU) 20. The ECU 20 is electrically connected to the engine 1, the first motor generator 2, the second motor generator 3 and the like so as to transmit a control command signal. The ECU 20 is mainly configured by a microcomputer, and is configured to perform computation using input data and data and a program stored in advance, and to output a result of the computation as a control command signal. The data input to the ECU 20 includes a vehicle speed, a wheel speed, an accelerator opening, a remaining charge (SOC) of the power storage device and the like. The data stored in the ECU 20 in advance includes a map in which each driving mode is determined, a map in which an optimum fuel consumption operating point of the engine 1 is determined, a map in which required power Pe_req of the engine 1 is determined and the like. The ECU 20 outputs, as control command signals, start and stop command signals of the engine 1, a torque command signal of the first motor generator 2, a torque command signal of the second motor generator 3, a torque command signal of the engine 1 and the like.

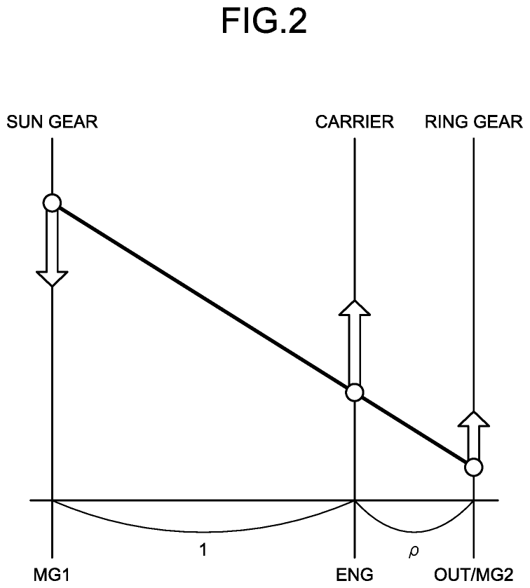

FIG. 2 is an alignment chart of the power split mechanism 4 constituted by a single pinion type planetary gear mechanism of FIG. 1. In the alignment chart illustrated in FIG. 2, a vertical line representing the carrier 9 (engine shaft) is located between a vertical line representing the sun gear 7 (first motor generator shaft) and a vertical line representing the ring gear 8 (second motor generator shaft and output shaft). When an interval between the vertical line indicating the sun gear 7 and the vertical line indicating the carrier 9 is “1”, an interval between the vertical line indicating the carrier 9 and the vertical line indicating the ring gear 8 is an interval equivalent to a gear ratio ρ. Note that the gear ratio ρ is a ratio between the number of teeth of the sun gear 7 and the number of teeth of the ring gear 8 in the planetary gear mechanism constituting the power split mechanism 4. The distance from the base line on the line indicating each of the rotating elements indicates the rotation speed of each of the rotating elements, and a line connecting points each indicating the rotation speed of each of the rotating elements is a straight line. Note that the arrows in FIG. 2 each indicate the directions of the torque of each of the rotating elements.

The alignment chart illustrated in FIG. 2 indicates an operation state in the hybrid traveling mode. In the hybrid traveling mode, the vehicle travels mainly using the power of the engine 1. That is, the engine 1 outputs a required engine torque Te_req according to a required driving force. In this case, the first motor generator 2 functions as a generator, outputs a torque in the direction opposite to the rotation direction of the engine 1 (negative rotation direction), and serves as a reaction force receiver that supports a reaction force of the requested engine torque Te_req.

The relationship between maximum torque Te_max that can be output by the engine 1 and maximum torque Tg_max that can be output by the first motor generator 2 in the power train illustrated in FIG. 1 is set so that torque acting on the carrier 9 in a case where the maximum torque Te_max that can be output by the engine 1 is output when an engine rotation speed Ne is increased based on an acceleration request is larger than torque acting on the carrier 9 in a case where the maximum torque Tg_max that can be output by the first motor generator 2 is output when the engine rotation speed Ne is increased based on the acceleration request. When the relationship between the maximum torque Te_max of the engine 1 and the maximum torque Tg_max of the first motor generator 2 is expressed by a mathematical expression in consideration of the gear ratio ρ, Equation (1) below can be obtained.

Te_max>−((1+ρ)/ρ)×Tg_max (1)

Note that the torque increase for increasing the output torque of the engine 1 is performed by, for example, a supercharger 21. As the supercharger 21, a mechanical supercharger (supercharger) driven by the power of the output shaft la of the engine 1 or an exhaust type supercharger (turbocharger) driven by the kinetic energy of exhaust gas can be used.

The hybrid traveling mode in the hybrid vehicle Ve is a traveling mode in which the hybrid vehicle Ve is caused to travel mainly using the engine 1 as a power source as described above. Specifically, by connecting the engine 1 and the power split mechanism 4, the power output from the engine 1 can be transmitted to the drive wheel 6. As described above, when transmitting the power output from the engine 1 to the drive wheel 6, the reaction force acts from the first motor generator 2 on the power split mechanism 4. Therefore, the sun gear 7 in the power split mechanism 4 is caused to function as a reaction force element so that the torque output from the engine 1 can be transmitted to the drive wheel 6. That is, the first motor generator 2 outputs a reaction force torque corresponding to the required engine torque Te_req in order to apply a torque corresponding to the required engine torque Te_req based on the acceleration request to the drive wheel 6.

In addition, the first motor generator 2 can arbitrarily control the rotation speed according to the value of the supplied current and the frequency thereof. Therefore, the engine rotation speed Ne can be arbitrarily controlled by controlling the speed of the first motor generator 2. Specifically, the required driving force is obtained according to the accelerator opening, the vehicle speed and the like, which are determined by a depression amount of an accelerator pedal by a driver. Further, the required power Pe_req of the engine 1 is obtained based on the required driving force. Further, the required engine torque Te_req required by a driver is obtained from the required power Pe_req of the engine 1 and the current engine rotation speed Ne. Then, the operating point of the engine 1 is determined from the optimum fuel efficiency line at which the fuel efficiency of the engine 1 becomes good. Further, the rotation speed of first motor generator 2 is controlled so as to obtain the operating point of engine 1 determined as described above. That is, according to the torque transmitted from the engine 1 to the power split mechanism 4, the torque Tg or the rotation speed of the first motor generator 2 is controlled. Specifically, the rotation speed of first motor generator 2 is controlled so that the engine rotation speed Ne is controlled to a target engine rotation speed Ne_req. In this case, since the rotation speed of the first motor generator 2 can be continuously changed, the engine rotation speed Ne can also be continuously changed.

As described above, the engine rotation speed Ne is controlled by the first motor generator 2, and the torque Tg of the first motor generator 2 is controlled according to the required engine torque Te_req. In this case, the first motor generator 2 functions as a reaction force element as described above. Further, the control of the engine rotation speed Ne requires inertia torque for increasing the engine rotation speed Ne by, for example, an acceleration request. In this case, the inertia torque is a positive value. Specifically, the engine rotation speed Ne is increased in a state where the current actual engine rotation speed Ne is lower than the target engine rotation speed Ne_req.

For example, in the case of steady traveling or a request for smooth acceleration, the first motor generator 2 controls the engine rotation speed Ne as described above. That is, the inertia torque for maintaining or smoothly increasing the engine rotation speed Ne is output by the first motor generator 2. Therefore, if feedback torque Tg_fb when a feedback system is configured with respect to the target engine rotation speed Ne_req, and feedforward torque Tg_ff for improving the responsiveness of the feedback control are defined, the torque Tg output by the first motor generator 2 can be expressed as Equation (2) below.

Tg=−(ρ/(1+ρ))×Te_req+Tg_fb+Tg_ff (2)

Note that “−(ρ/(1+ρ))×T_req” in Equation (2) above indicates the above-described reaction force torque. Further, the relationship between pieces of torque of the respective rotating elements in the planetary gear mechanism constituting the power split mechanism 4 described above is determined based on the gear ratio ρ (ratio between the number of waves of the sun gear 7 and the number of teeth of the ring gear 8). Therefore, the torque Tg output by the first motor generator 2 can be obtained using Equation (2) above.

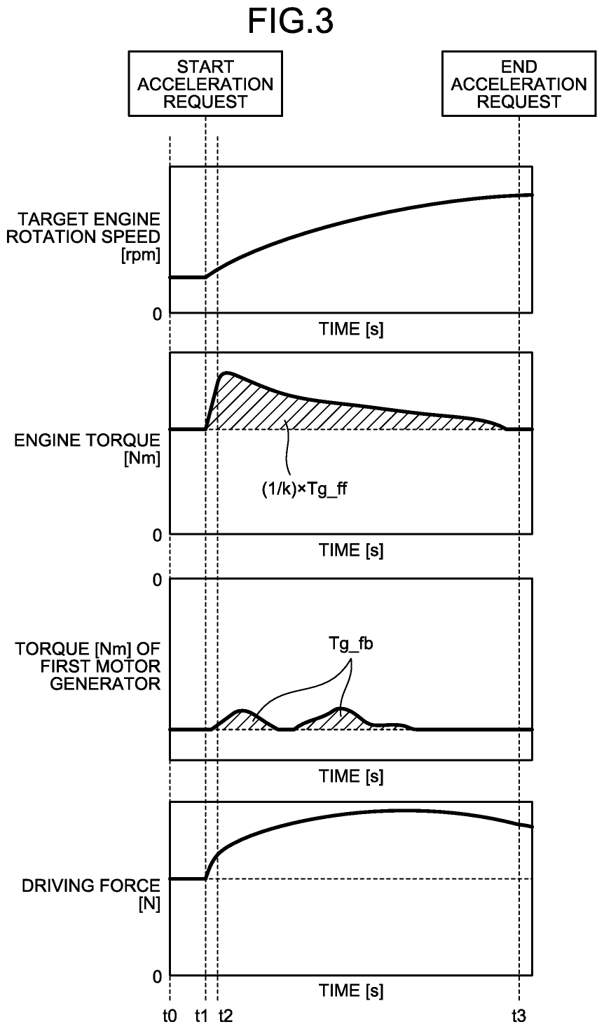

FIG. 3 is a time chart illustrating an example of changes in the target engine rotation speed Ne_req, the engine torque Te, the torque Tg of the first motor generator 2, and the driving force when the vehicle is accelerated from the steady traveling.

First, the hybrid vehicle Ve performs HV traveling, and is traveling steady at a time point t0. Therefore, the target engine rotation speed Ne_req at the time point t0 is a constant speed, and the parameters of the engine torque Te, the torque Tg of the first motor generator 2, and the driving force are also constant outputs.

Next, at a time point t1, a relatively large acceleration request such as rapid acceleration is made, and the engine rotation speed Ne is increased. Specifically, the engine rotation speed Ne is increased steeply from the time point t1 to a time point t2, and the engine torque Te is also output steeply from the time t1 to the time t2 accordingly. Note that the engine torque Te is an engine torque Te_cmd commanded to the engine 1, and total torque obtained by adding the feedforward torque Tg_ff converted to the engine shaft to the required engine torque Te_req. In this time chart, the engine torque Te at the time point t2 is the maximum value.

Further, the torque Tg of the first motor generator 2 from the time point t1 to the time point t2 is increased steeply from the time point t1 to the time point t2 by adding the feedback torque Tg_fb to the reaction force torque corresponding to the required engine torque Te_req. Then, the driving force output from the drive wheel 6 is also increased steeply from the time point t1 to the time point t2. With this, in addition to engine direct torque not decreasing, the torque Tg of the first motor generator 2 does not decrease. Thus, the power generation amount of the first motor generator 2 also increases. Therefore, in addition to the engine torque direct torque, the driving force output from the second motor generator 3 also increases, and as a result, the driving force output from the drive wheel 6 of the hybrid vehicle Ve as a whole also increases.

Next, the target engine rotation speed Ne_req in the transitional period from the time point t2 to a time point t3 increases, but the change rate decreases. That is, it can be determined that the engine rotation speed Ne has increased to a certain speed. Therefore, the inertia torque (feedforward torque Tg_ff) also decreases due to the decrease in the change rate of the engine rotation speed Ne. Further, as the inertia torque decreases as described above, the engine torque Te also decreases and is output from the time point t2 to the time point t3. Further, the torque Tg of the first motor generator 2 decreases by the intermittent decrease of the feedforward torque Tg_ff from the time point t2 to the time point t3, so that the power generation amount of the first motor generator 2 also decreases. As the engine torque Te and the power generation amount of the first motor generator 2 decrease, the driving force output from the second motor generator 3 increases in addition to the engine torque direct torque, but the change rate decreases.

Then, at the time point t3, the target engine rotation speed Ne_req becomes substantially constant, and the engine torque Te and the torque Tg of the first motor generator 2 decrease to substantially the same output as in the steady traveling at the time point t0. Therefore, it can be determined that the acceleration request has been completed at the time point t3.

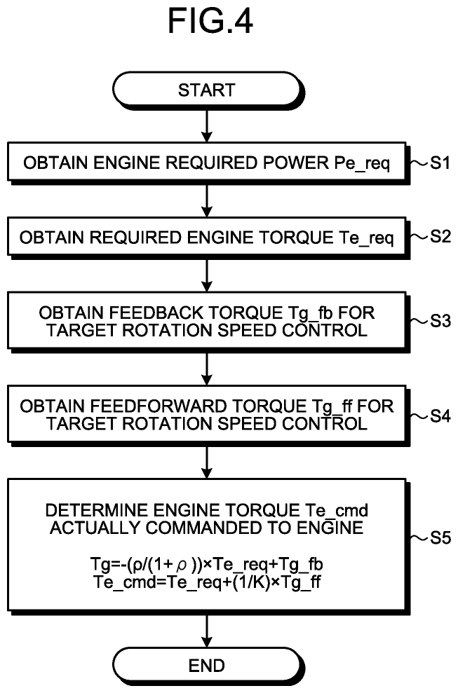

FIG. 4 is a flowchart illustrating an example of control performed by the ECU 20 to compute the engine torque Te_cmd that is actually commanded to the engine 1.

First, the ECU 20 obtains the required power Pe_req of the engine 1 (step S1). The required power Pe_req of the engine 1 is obtained from the required driving force obtained based on the accelerator opening and the vehicle speed determined by the depression amount of the accelerator pedal by a driver, and is determined, for example, by referring to a prepared map or the like.

Next, the ECU 20 obtains the required engine torque Te_req (step S2). The required engine torque Te_req is, for example, an engine torque required by a driver, and is a value obtained based on an operation amount of the accelerator pedal by the driver and the like. Therefore, it can be obtained from the required driving force and the current engine rotation speed Ne.

Next, the ECU 20 obtains the feedback torque Tg_fb for the target rotation speed control (step S3). Next, the ECU 20 obtains the feedforward torque Tg_ff for the target rotation speed control (step S4). Note that the feedback torque Tg_fb and the feedforward torque Tg_ff are torque required to increase the engine rotation speed Ne based on the acceleration request, are torque for changing the rotation speed of the engine 1 or the first motor generator 2, and are obtained by the feedback control and the feedforward control. The feedback torque Tg_fb is obtained based on a deviation between the actual engine rotation speed Ne in the current routine and the target engine rotation speed Ne_req in the current routine. Further, the feedforward torque Tg_ff is obtained based on a deviation between the target engine rotation speed Ne_req in the current routine and a target engine rotation speed Ne_req+1 after one routine.

Note that, when the feedforward torque Tg_ff is the inertia torque, the feedforward torque Tg_ff is obtained by multiplying an increase dNe of the target engine rotation speed to be increased during one routine by an inertia moment Ie obtained by summing the components corresponding to the engine shaft of the inertia torque of the engine 1 and the first motor generator 2, and further multiplying shaft torque of the engine 1 by a conversion coefficient K for converting to shaft torque of the first motor generator 2. This can be simply expressed as Equation (3) below.

Tg_ff=Ie×dNe/dt (3)

Note that, in Equation (3) above, the influence on the rotation fluctuation of the rotation shaft of the second motor generator 3 is relatively small, and is not considered.

Here, when the target engine rotation speed of the engine 1 determined from the required power Pe_req of the engine 1 is the target engine rotation speed Ne_req, if the target engine rotation speed Ne_req is larger than the current engine rotation speed Ne, the feedforward torque Tg_ff is a positive (Tg_ff>0). In this case, terms other than the reaction force torque of the engine 1 in Equation (2) above may be as represented by Equation (4) below.

Tg_fb+Tg_ff>0 (4)

If the relationship of Equation (4) above is satisfied, the reaction force torque generated by the first motor generator 2 is decreased, which leads to a reduction in driving force.

Therefore, the ECU 20 eliminates the feedforward torque Tg_ff of Equation (2) above from the torque Tg output from the first motor generator 2 as represented by Equation (5) below, and determines and outputs torque obtained by adding the feedforward torque Tg_ff converted to the engine shaft to the required engine torque Te_req as represented by Equation (6) below as the engine torque Te_cmd (step S5).

Tg=−(ρ/(1+ρ))×Te_req+Tg_fb (5)

Te_cmd=Te_req+(1/K)×Tg_ff (6)

With this, when the engine rotation speed Ne is to be increased, the control for following the target engine rotation speed Ne_req can be performed with the torque Tg of the first motor generator 2 having a fast response. Thus, as compared with the case where the feedback torque Tg_fb is output from the engine 1 as in Equation (2) above, the followability to the target rotation speed can be improved. Further, since the feedforward torque Tg_ff is compensated on the engine 1 side, terms other than the reaction force represented by the above equation (4) can be reduced correspondingly, and a decrease in driving force can be suppressed.

In the present embodiment, the required engine torque Te_req can be transmitted to the drive shaft 5 and the drive wheel 6 without being affected by the inertia torque when the engine rotation speed Ne is accelerated from a low speed, so that a decrease in acceleration performance such as acceleration responsiveness can be suppressed.

Further, since the first motor generator 2 can output the reaction force torque corresponding to the required engine torque Te_req, the amount of power generated by the first motor generator 2 increases. Therefore, the power that can be supplied to the second motor generator 3 increases, and the driving force output from the second motor generator 3 can be increased accordingly, so that the acceleration performance can be improved.

Here, in the case of the conventional design method, when the maximum torque Te_max (the upper limit of the engine torque Te) is determined, the maximum torque Tg_max of the first motor generator 2 (the upper limit of the torque Tg of the first motor generator 2) is set as represented by Equation (7) below accordingly.

Tg_max=−(ρ/(1+ρ))×Te_max+α (7)

Note that α in Equation (7) above is a design margin value.

Then, when, after the maximum torque Tg_max of the first motor generator 2 is set as in the above equation (7), the maximum torque Te_max is increased to a value of Te_max2 larger than this, for example, when a change to a high torque engine is made with the electric system and the transmission as they are, the surplus torque of the engine 1 that cannot be received by the first motor generator 2 in a steady state can be used as (1/K)×Tg_ff in Equation (6) above. In the present embodiment, the power performance can be improved only by improving the engine torque Te.

Note that Equations (5) and (6) above may be replaced by Equations (8) and (9).

Tg=−(ρ/(1+ρ))×Te_req+Tg_fb+Kge×Tg_ff (8)

Te_cmd=Te_req+(1/Kge)×Tg_ff (9)

In Equations (8) and (9) above, Kge is a distribution ratio of the inertia torque to the first motor generator 2 and the engine 1, and satisfies the relationship 0≤Kge<1.

With this, when the distribution ratio Kge is increased, a certain amount of inertia torque is shared on the first motor generator 2 side, and a margin can be provided for the maximum torque of the first motor generator 2. Further, in this case, even if the feedback torque Tg_fb increases to the negative side, the frequency of exceeding the maximum torque of the first motor generator 2 is reduced, and the followability of the target rotation speed control to the target value can be improved.

Further, the control described in the present embodiment is particularly effective because there is a need to quickly increase the engine rotation speed Ne so as to rotate a turbine of the supercharger 21 in a system in which the engine 1 including the supercharger 21 is combined as in the hybrid vehicle Ve according to the present embodiment.

### INDUSTRIAL APPLICABILITY

According to the present invention, it is possible to provide a hybrid vehicle that can improve the followability to a target rotation speed when the engine rotation speed is increased.

### REFERENCE SIGNS LIST

1 Engine

2 First motor generator

3 Second motor generator

4 Power split mechanism

5 Drive shaft

6 Drive wheel

7 Sun gear

8 Ring gear

9 Carrier

12 First drive gear

20 ECU

21 Supercharger

Ve Hybrid vehicle

1. A hybrid vehicle comprising:
an engine;
an output member that transmits a driving force to drive wheels;
a rotating electric machine; and
a power split mechanism that splits and transmits a driving force output from the engine to the output member and the rotating electric machine, wherein
the power split mechanism includes at least three rotating elements, which are an input element, connected to the engine, a reaction force element, connected to the rotating electric machine, and an output element, connected to the output member,
when an engine rotation speed is to be increased, an engine torque is output by adding an engine inertia torque to an engine required torque, and a reaction force torque, corresponding to the engine required torque, is output by the rotating electric machine, and
a feedback torque, constituting a feedback system with respect to a target rotation speed of the engine, is output as the reaction force torque of the rotating electric machine.

2. The hybrid vehicle according to claim 1,
wherein the engine includes a supercharger, and
an output torque of the engine is increased by operating the supercharger.
